(19) United States
(12) Patent Application Publication
(10) Pub. No.: US 2025/0251093 A1
(43) Pub. Date: Aug. 7, 2025

(54) GAS UTILIZATION APPARATUS

(71) Applicant: TOYOTA JIDOSHA KABUSHIKI KAISHA, Toyota-shi (JP)

(72) Inventor: Daisuke SATOYA, Nisshin-shi (JP)

(73) Assignee: TOYOTA JIDOSHA KABUSHIKI KAISHA, Toyota-shi (JP)

(21) Appl. No.: 18/959,980

(22) Filed: Nov. 26, 2024

(30) Foreign Application Priority Data
Feb. 7, 2024 (JP) 2024-017345

(51) Int. Cl. F17C 13/04

(52) U.S. Cl. CPC F17C 13/04; F17C 2205/0326; F17C 2205/0352; F17C 2221/012; F17C 2250/03; F17C 2250/043; F17C 2270/0168; F17C 2270/0184

(57) ABSTRACT

The gas utilization apparatus disclosed herein includes a gas tank having a first valve, a gas utilization device having a second valve, a gas pipe connecting the first valve and the second valve, a third valve provided in the gas pipe, and a controller. The controller alternately executes opening and closing of the first valve and opening and closing of the third valve in a state in which the second valve is closed. By the process, an internal pressure of the gas pipe between the second valve and the third valve gradually rises. The controller opens the first valve, the second valve, and the third valve when the internal pressure of the gas pipe between the second valve and the third valve reaches a predetermined threshold pressure.

### CROSS-REFERENCE TO RELATED APPLICATION

This application claims priority to Japanese Patent Application No. 2024-017345 filed on Feb. 7, 2024, incorporated herein by reference in its entirety.

### BACKGROUND

### 1. Technical Field

The technology disclosed by the present specification relates to a gas utilization apparatus that includes a gas tank and a gas utilization device.

### 2. Description of Related Art

A gas tank includes a valve at a gas outlet. A gas utilization device includes a valve at a gas inlet. For convenience of explanation, the valve of the gas tank will be called a first valve, and the valve of the gas inlet of the gas utilization device will be called a second valve. The first valve and the second valve are connected by a gas pipe, and when both of the valves are opened, gas in the gas tank is supplied to the gas utilization device. A pressure reducing valve or a regulating valve is used for the second valve when a range of an appropriate gas pressure range of the gas utilization device is lower than an internal pressure of the gas tank (for example, WO 2018/019936 A).

### SUMMARY

When a gas tank is used in various types of gas utilization devices, there may be types within the gas utilization devices in which an impact resistance pressure of the second valve is low. The gas tank is connected to the gas utilization device, and the first valve is opened. Gas from the gas tank reaches the second valve at once. A pressure higher than the internal pressure of the gas tank is instantaneously applied to the second valve accompanying a rapid change in pressure. The pressure at this time is called an impact pressure or a collision pressure. If an impact resistance pressure of the second valve is not sufficient, the second valve may suffer damage. The present specification provides technology that suppresses an impact pressure applied to a valve of a gas utilization device.

A gas utilization apparatus disclosed by the present specification includes
a gas tank that has a first valve,
a gas utilization device that has a second valve,
a gas pipe that connects the first valve and the second valve,
a third valve provided in the gas pipe, and
a controller.

The controller alternately executes opening and closing of the first valve and opening and closing of the third valve in a state in which the second valve is closed. By the process, an internal pressure of the gas pipe between the second valve and the third valve gradually rises. The controller opens the first valve, the second valve, and the third valve when the internal pressure of the gas pipe between the second valve and the third valve reaches a predetermined threshold pressure. In the gas utilization apparatus disclosed by the present disclosure, a pressure applied to the second valve gradually rises. An impact pressure applied to the valve (second valve) of the gas utilization device is suppressed.

Details of the technique disclosed in the present specification and further improvements will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a gas utilization apparatus (FC power generation device) according to an embodiment.

### DETAILED DESCRIPTION OF EMBODIMENTS

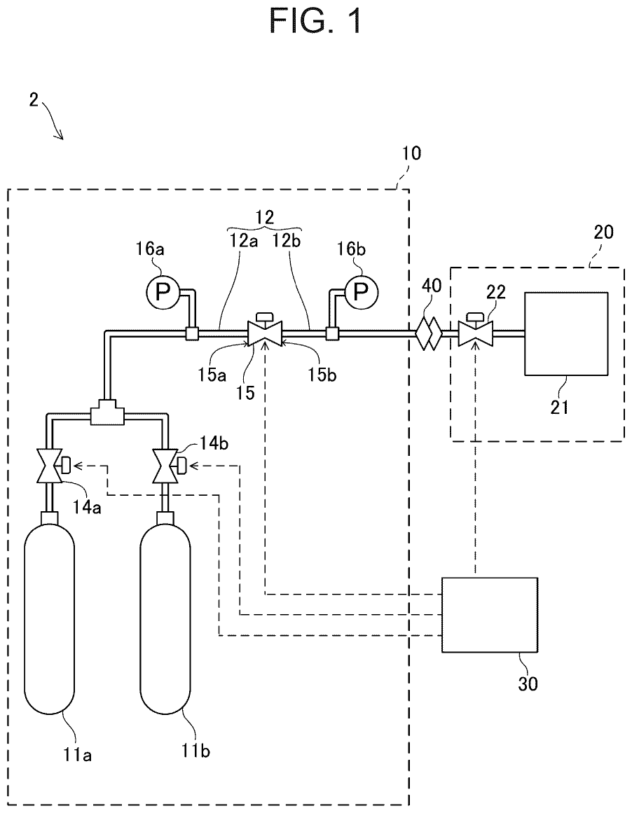

A gas utilization apparatus according to an embodiment will be described with reference to the drawings. The gas utilization apparatus of the embodiment is FC power generation device 2. Here, “FC” is an abbreviation for “FuelCell”. FC power generation device 2 is also generally referred to as a fuel cell. FIG. 1 is a block-diagram of FC power generation device 2.

FC power generation device 2 includes a hydrogen-storage module 10, a FC unit 20, and controllers 30. The controllers 30 may be included in either the hydrogen-storage module 10 or FC unit 20. FC power generation device 2 is a device that supplies the hydrogen gas in the hydrogen tank 11a, 11b of the hydrogen storage module 10 to FC body 21 of FC unit 20 and generates electric power.

The hydrogen storage module 10 comprises two hydrogen reservoir 11a, 11b for storing hydrogen gases. The hydrogen tank 11a comprises a tank valve 14a and the hydrogen tank 11b comprises a tank valve 14b. The tank valve 14a (14b) is provided at the gas outlet of the hydrogen tank 11a (11b). When the tank valve 14a (14b) is opened, hydrogen gas is discharged from the hydrogen tank 11a (11b).

FC unit 20 includes a FC body 21 and an inlet valve 22. The inlet valve 22 and FC body 21 are connected by a gas pipe. The inlet valve 22 is provided at the gas inlet of FC unit 20 (gas utilization device).

The two tank valve 14a, 14b (two hydrogen tanks 11a and 11b) and the inlet valve 22 (FC body 21) are connected by a gas pipe 12. A solenoid valve 15 is provided in the middle of the gas pipe 12. For convenience of explanation, in the gas pipe 12, a space between the solenoid valve 15 and the tank valve 14a, 14b is referred to as a first sub-pipe 12a, and a space between the solenoid valve 15 and the inlet valve 22 is referred to as a second sub-pipe 12b.

A fluid coupler 40 is provided in the middle of the gas pipe 12. In the example of FIG. 1, a fluid coupler 40 is provided in the middle of the second sub-pipe 12b. The gas pipe 12 is separable by a fluid coupler 40. That is, the hydrogen-storage module 10 and FC unit 20 are separable. The hydrogen-storage module 10 may also be connected to another gas utilization device that differs from FC unit 20.

One end of the first sub-pipe 12a is connected to the tank valve 14a, 14b, and the other end of the first sub-pipe 12a is connected to the inlet 15a of the solenoid valve 15. One end of the second sub-pipe 12b is connected to the outlet 15b of the solenoid valve 15, and the other end of the second sub-pipe 12b is connected to the inlet valve 22.

The expressions “inlet 15a” and “outlet 15b” of the solenoid valve 15 are used for convenience in distinguishing two ports of the valve. For convenience of explanation, the internal pressure of the first sub-pipe 12a is referred to as an upstream pipe pressure, and the internal pressure of the second sub-pipe 12b is referred to as a downstream pipe pressure. The upstream pipe pressure corresponds to the pressure on the inlet 15a side of the solenoid valve 15, and the downstream pipe pressure corresponds to the pressure on the outlet 15b side of the solenoid valve 15. Further, the downstream pipe pressure corresponds to the pressure applied to the solenoid valve 15.

The first sub-pipe 12a is provided with a pressure sensor 16a for measuring the upstream pipe pressure, and the second sub-pipe 12b is provided with a pressure sensor 16b for measuring the downstream pipe pressure. Although not shown, the gas pipe 12 is provided with several check valves (safety valves). In addition, FC power generation device 2 may include a plurality of pressure sensors in addition to those illustrated in FIG. 1.

The tank valve 14a, 14b, the inlet valve 22, and the solenoid valve 15 are controlled by the controllers 30. The dotted arrow line in the FIGURE represents the control line. In addition, the measurement data of the pressure sensor 16a, 16b is sent to the controllers 30.

Prior to supplying the hydrogen gas from the hydrogen tank 11a, 11b to FC body 21, the controllers 30 control the valves in the following manner.

First, the controller 30 alternately repeats the opening and closing of the tank valve 14a, 14b and the opening and closing of the solenoid valve 15 while the inlet valve 22 is closed. More specifically, the controllers 30 open and close the tank valve 14a, 14b in a state where the solenoid valve 15 is closed, and then open and close the solenoid valve 15 in a state where the tank valve 14a, 14b is closed. The controller 30 repeats this procedure.

When the controller 30 opens and closes the tank valve 14a, 14b with the solenoid valve 15 closed, the hydrogen gas flows into the first sub-pipe 12a, and the upstream pipe pressure (the internal pressure of the first sub-pipe 12a) rises to the internal pressure of the hydrogen tank 11a, 11b. At this time, since the solenoid valve 15 is closed, the downstream pipe pressure (the internal pressure of the second sub-pipe 12b) does not change. When the controller 30 then opens and closes the solenoid valve 15 with the tank valve 14a, 14b closed, the hydrogen gas in the first sub-pipe 12a spreads to the second sub-pipe 12b. As a result, the upstream pipe pressure decreases and the downstream pipe pressure increases. However, since the tank valve 14a, 14b is closed, the upstream pipe pressure and the downstream pipe pressure do not increase up to the tank internal pressure.

When the opening and closing of the tank valve 14a, 14b and the opening and closing of the solenoid valve 15 are alternately repeated, the downstream-pipe pressure gradually increases. If the tank valve 14a, 14b and the solenoid valve 15 are opened at the same time when the downstream pipe pressure is atmospheric pressure, a large impact pressure is generated in the inlet valve 22. The inlet valve 22 may be damaged. In FC power generation device 2, since the downstream pipe pressure gradually increases, the impact pressure applied to the inlet valve 22 is suppressed.

When the downstream pipe pressure reaches a predetermined threshold pressure, the controller 30 opens the tank valve 14a, 14b and the solenoid valve 15, and then opens the inlet valve 22. By this process, the hydrogen gas is started to be supplied from the hydrogen tank 11a, 11b to FC body 21.

The points to be noted regarding the technique described in the embodiment will be described. When the tank valve 14a, 14b is opened while the solenoid valve 15 is closed, the upstream pipe pressure (the internal pressure of the first sub-pipe 12a) rises to the tank internal pressure at once. The solenoid valve 15 needs to withstand the impact pressure at this time. That is, the impact resistance pressure of the solenoid valve 15 needs to be higher than the impact resistance pressure of the inlet valve 22. The solenoid valve 15 belongs to the hydrogen storage module 10. Whatever type of gas utilization device is connected to the hydrogen storage module 10, the inlet valve of the gas utilization device is protected.

The first sub-pipe 12a may be longer than the second sub-pipe 12b. As compared with the second sub-pipe 12b, the longer the first sub-pipe 12a is, the smaller is the increased flow rate of the downstream-pipe pressure when the solenoid valve 15 is opened and closed. In other words, the longer the first sub-pipe 12a, the more gradual the downstream-tube pressure increases. Each time the solenoid valve 15 is opened or closed, the impact pressure applied to the inlet valve 22 decreases.

The above-described threshold pressure is set to be equal to or lower than the internal pressure (tank internal pressure) of the hydrogen tank 11a, 11b. When the solenoid valve 15 is opened and closed after the tank valve 14a, 14b is opened and closed, the downstream pipe pressure increases by a dP. Here, dP=“internal pressure of the hydrogen-tank 11a, 11b”×“length of the second sub-pipe 12b”/“length of the gas pipe 12”. The threshold pressure may be set to be equal to or lower than the tank internal pressure and larger than the “tank internal pressure-dP”. If the condition is met, the increment of the downstream tube pressure does not exceed dP. The threshold pressure may be equal to the tank internal pressure.

The tank valve 14a, 14b and the solenoid valve 15 may be simple opening and closing valves (stop valves) that can take either of two states: “open” or “closed”. Such valves are inexpensive. The inlet valve 22 may be a simple opening and closing valve (stop valve) or a pressure reducing valve (or pressure regulating valve). The pressure reducing valve (or pressure regulating valve) is a valve capable of making the pressure on the gas outlet side lower than the pressure on the gas inlet side. When the proper pressure range of the hydrogen gas used by FC body 21 is lower than the internal pressure of the hydrogen tank 11a, 11b, it is desirable to use a pressure reducing valve (or a pressure regulating valve) as the inlet valve 22.

The tank valve 14a, 14b is an exemplary first valve. The inlet valve 22 is an example of a second valve. The solenoid valve 15 is an example of a third valve. The second valve may be a valve of a type other than “electromagnetic”.

The controllers 30 may open and close both of the tank valve 14a, 14b, or may open and close the other valve while keeping one of the tank valve 14a, 14b closed. That is, the controllers 30 may alternately open and close the other tank valve and open and close the solenoid valve 15 while keeping one of the tank valve 14a, 14b closed. The controller 30 may open and close the other with one of the tank valve 14a, 14b closed, then open and close the solenoid valve 15, then open and close the other of the tank valve 14a, 14b, and then open and close the solenoid valve 15.

The gas utilization apparatus (FC power generation device 2) of the embodiment includes two hydrogen-tank 11a, 11b. The gas utilization apparatus may include three or more gas tanks, or may include only one gas tank.

FC power generation device 2 is an exemplary gas utilization apparatus. FC body 21 is an exemplary gas utilization device. A typical gas utilization apparatus is a fuel cell electric vehicle including a hydrogen gas tank and a fuel cell. The technique disclosed in the present specification may be any device including a gas tank and a gas utilization device, and may be applied to a device other than FC power generation device. The gas utilization device may be a device other than FC body 21. The gas used may be a gas other than hydrogen gas. The gas utilization apparatus disclosed herein is an apparatus in which gas in a gas tank is supplied to a gas utilization device.

Although specific examples of the disclosure have been described in detail above, the examples are merely examples and do not limit the scope of claims. The technique described in the claims includes various modifications and variations of the specific examples exemplified above. The technical elements described in the present specification or in the drawings exhibit technical usefulness alone or in various combinations, and are not limited to the combinations described in the claims at the time of filing the application. In addition, the technique exemplified in the present specification or drawings can achieve a plurality of purposes at the same time, and achieving one of the purposes itself has technical usefulness.

What is claimed is:

1. A gas utilization apparatus, comprising:
a gas tank that has a first valve;
a gas utilization device that has a second valve;
a gas pipe that connects the first valve and the second valve;
a third valve provided in the gas pipe; and
a controller that alternately executes opening and closing of the first valve and opening and closing of the third valve in a state in which the second valve is closed and opens the first valve, the second valve, and the third valve when an internal pressure of the gas pipe between the second valve and the third valve reaches a predetermined threshold pressure.

2. The gas utilization apparatus according to claim 1, wherein an impact resistance pressure of the third valve is higher than an impact resistance pressure of the second valve.

3. The gas utilization apparatus according to claim 1, wherein
the first valve and the third valve are each an opening and closing valve that switches between opening and closing, and
the second valve is a pressure reducing valve in which a pressure on an outlet side is lower than a pressure on an inlet side.

4. The gas utilization apparatus according to claim 1, wherein the gas pipe includes a first sub-pipe that connects the first valve and the third valve and a second sub-pipe that connects the third valve and the second valve, the first sub-pipe being longer than the second sub-pipe.
